(19) United States
(12) Patent Application Publication
(10) Pub. No.: US 2003/0026746 A1
(43) Pub. Date: Feb. 6, 2003

(54) Regenerating spent pickling liquor

(76) Inventors: Douglas R. Olsen, Pawling, NY (US); Charles D. Blumenschein, Pittsburgh, PA (US)

Correspondence Address: DOUGLAS G GLANTZ, ATTORNEY AT LAW, 5260 DEBORAH COURT, DOYLESTOWN, PA, 18901, US

(21) Appl. No.: 10/245,418

(22) Filed: Sep. 17, 2002

Related U.S. Application Data
(62) Division of application No. 09/740,465, filed on Dec. 19, 2000.
(60) Provisional application No. 60/174,522, filed on Jan. 5, 2000.

(51) Int. Cl. C01G 49/14; B01D 9/00

(52) U.S. Cl. 422/187; 423/558; 423/DIG. 1; 423/146; 422/188; 422/189; 422/245.1

(57) ABSTRACT

Apparatus and method for regenerating spent pickling liquor from the acid pickling of a metal are disclosed. Acid pickling of a metal uses a first acid and forms a spent pickling liquor (SPL). A second acid added to the spent pickling liquor, under specific low temperatures produces a metal salt of the second acid. The metal salt of the second acid is crystallized and removed from a regenerated first acid. In one aspect, hydrochloric acid is regenerated from a pickling process for iron or steel, using sulfuric acid as the second acid, and ferrous sulfate heptahydrate crystals are produced. Regenerated hydrochloric acid is recycled to the acid pickling process.

### BACKGROUND OF THE INVENTION

1. Technical Field

This invention relates to an apparatus and method for regenerating spent pickling liquor. In one aspect, this invention relates to an apparatus and method for regenerating spent pickling liquor from the acid pickling of a metal.

2. Background

Pickling is a process for the removal of a scale, oxides, or other impurities from a metal surface by immersion in an inorganic acid, usually sulfuric acid, hydrochloric acid, nitric, hydrofluoric, or phosphoric acid.

Pickling processes are used to clean the metal surface, e.g., steel. The pickling process removes thin layers of the scale and oxides formed on the metal surface during process operations such as rolling and annealing, and also from exposure to water and the environment. Hot rolled steel, for example, has very thin layers of scale, e.g., at depths of from about 0.000228 inch to about 0.000380 inch thick.

Pickling of ferrous metals, such as steel strip, sheet, tubes, or wire, removes metal oxides and scale, usually with a commercial hydrochloric acid pickle liquor heated to a temperature as high as 200° F. (Fahrenheit) or more by closed circuit steam-acid heat exchangers. A ferrous chloride solution is a principal by-product of the pickling process.

Pickling process solutions of sulfuric acid and hydrochloric acid are used to pickle the steel. The pickling process starts with a theoretical dosage of hydrochloric acid to remove the scale. For example, about nine pounds of anhydrous hydrochloric acid or about 14 pounds of about 66° Be (93.5 wt. %) sulfuric acid, per 1,000 square feet of steel surface are required for the pickling process. Heavier gauge steel sheet has proportionally less surface area and requires less acid per ton in the pickling process.

The rate of scale removal varies inversely with concentration and temperature. The usual concentration is 15% at or above 100° C. The rate also is increased by electrolysis. Operating conditions for batch pickling in hydrochloric acid solutions involve acid concentrations in the range from about 8 to about 12 grams per 100 milliliters, temperatures in the range from about 100° F. to about 110° F., and immersion times in the range from about 5 minutes to about 15 minutes. Operating conditions for continuous pickling in hydrochloric acid solution involve acid concentrations in the range of about 2 grams to about 20 grams per 100 milliliters, temperatures in the range from about 150° F. to about 200° F., and immersion times in the range from about 1 minute to about 2 minutes.

### INTRODUCTION TO THE INVENTION

Although currently available pickling processes have gained widespread acceptance by the public, the current processes still have need of improvement in specific areas.

Sulfuric acid and hydrochloric acid are agents to pickle steel. Pickling is meant principally, a process to clean the steel before subsequent operations, principally by removing scale and oxides from previous operations such as rolling and annealing and also from exposure to water and the environment. Large scale pickling operations are conducted at temperatures up to 200° F.

In the course of pickling the iron or steel, hydrochloric acid or sulfuric acid are consumed by the reaction of the scale and the oxides of iron and other alloying metals to form ferrous chloride and ferrous sulfate, respectively. There are differences, however, in both the mechanism by which hydrochloric acid or sulfuric acid removes the scale and the ultimate condition of the metal surface after pickling.

Sulfuric acid dissolves principally the ferrous oxide (FeO) fractions of the scale. Sulfuric acid penetrates the scale by acting on the base metal, generating hydrogen which acts to pop off the unreacted scale of miscellaneous oxides into the acid. The carbon contained in the steel, exposed by the action of the acid on the metal, and other fine particles remain on the surface of the metal in a form called smut. The action of sulfuric acid is inhibited by the presence of increasing concentrations of iron salts in the pickling bath. Iron concentrations typically are maintained below 8 gms/100 ml. Sulfuric acid concentration is not practical for pickling when the acid concentration has dropped to less than 4 gms/100 ml.

Hydrochloric acid dissolves all of the scale and consistently leaves a uniform light gray finish on both low and high carbon steel. It does not leave smut behind on the surface of the metal. Rinsing is facilitated because of the high solubility of the chlorides compared to the sulfates. Overpickling is less likely with hydrochloric acid than with other acids. The amount of iron contained in the solution is as high as 13 g/100 ml without deleterious effect on pickling. Hydrochloric acid has been utilized in pickling baths until its concentration has reached as low as 1.5-2 gm/100 ml.

The pickling of the steel with hydrochloric acid produces a liquor containing FeCl₂ and HCl. The waste liquor often is discarded, adding to already existing pollution problems.

Conventionally, the spent pickle liquor (SPL) has been sent to a water treatment facility, a wastewater treatment facility, or a combination of water treatment facilities and wastewater treatment facilities for recovering a ferrous chloride value. The spent pickle liquor (SPL) can be treated in a wastewater treatment plant, injected into deep well, or regenerated by a roosting process.

In the cases where hydrochloric acid is the preferred acid, methods are sought to regenerate hydrochloric acid from the “spent pickle liquor” (SPL), because the acid is in greater demand than the by-product ferrous chloride. Two processes are used to regenerate hydrochloric acid, the Ruthner and the Lurgi processes. Both the Ruthner and the Lurgi processes are complete regeneration systems producing hydrochloric acid (20%) containing low iron concentrations, (0.25 weight percent Fe). The Ruthner process generates a powdered iron oxide as a by-product, and the Lurgi process generates a palletized oxide. Both processes treat the spent pickle liquor by a roasting process that produces distilled hydrochloric acid and by-product iron oxide.

High temperature systems for the regeneration of spent hydrochloric acid pickle liquors are necessary. In a roasting process, ferrous chloride in the spent pickle liquor is hydrolyzed in a reaction at approximately +840 degrees Fahrenheit to produce iron oxide and hydrogen chloride gas. The hydrogen chloride gas then is absorbed into water to form a suitable concentration of aqueous hydrochloric acid to be returned to the pickling line as a regenerated pickling liquor. The high temperatures involved in the roasting processes are disadvantageous for a number of reasons, including the relatively high maintenance and operating costs attendant high temperatures. Organic acid inhibitors used in acid pickle liquors are destroyed in the high temperatures. A distillation process has disadvantages of high distillation temperatures, the attendant high maintenance and operating costs, and the destruction of organic acid inhibitors.

The spent pickle liquor (SPL) is regenerated to iron oxide and about 18% hydrochloric acid by a spray roasting process. The principal hydrochloric acid spent pickle liquor (SPL) regeneration process is the acid spray roasting process, which converts the spent pickle liquor (SPL) to between about 18% to about 20% hydrochloric acid solution containing approximately 0.25% iron and a fine iron oxide dust. The iron oxide is used for manufacturing magnetic products or discarded. The spray roasting process has many disadvantages, including large equipment sizes, high capital costs, and high operating costs. Various methods have been introduced to treat the pickling waste liquor. As described in Beecher U.S. Pat. Nos. 4,382,916 and 4,222,997, the hydrochloric acid has been recovered from the pickle liquor. U.S. Pat. No. 4,382,916 operates in boiling the HCl which is standard prior art. Roasting is boiling under pressure. Beecher produces ferrous sulfate as a by-product. Beecher recovers the hydrochloric acid by condensing pickling liquor to remove HCl and water from the feed stream, boiling the feed stream. The concentrated pickle liquor then is added to sulfuric acid to produce ferrous sulfate. The HCl and water vapors are recovered using extensive heat recovery equipment.

A roasting process described in Barczak U.S. Pat. No. 4,436,681 recovers HCl from pickle liquor by injecting the pickle liquor into a roasting chamber at very high temperatures (1,600° F.) using a very high pressure to obtain a fine spray. The ferrous chloride is converted to Fe₂O₃ and HCl. The roasting process uses a great deal of energy and requires high maintenance costs. The Fe₂O₃ produced is of low marginal quality and value.

The products ferric oxide, ferrous sulfate, and HCl are of relatively low marginal value. The prior art processes are expensive to setup and operate and difficult to be justified economically.

Over one and a half billion gallons per year of spent pickle liquor (SPL) are produced containing iron or weak acid or a combination of iron and weak acid in integrated steel mills and by outside processors. Over 90% of this spent pickle liquor (SPL) is from hydrochloric acid-based steel pickling lines.

Hydrochloric acid-based metal pickling produces a spent pickle liquor (SPL) having low acid concentration and containing soluble ferrous chloride.

Hydrochloric acid reduces harmful over-pickling because the hydrochloric acid reacts mainly with the scale. Sulfuric acid, on the other hand, reacts directly with the steel itself.

The amount of iron present in the hydrochloric acid pickling solution is as high as about 13 grams per 100 milliliters without having a deleterious effect on pickling.

Hydrochloric acid has been utilized in pickling baths until its concentration has reached as low as about 1.5 grams to about 2 grams per 100 milliliters, or lower in the galvanizing industry where it is used to strip zinc from off-specification product.

Accordingly, there is a need for novel means and methods for treating and recycling spent pickle liquor (SPL).

Accordingly, there is a need for novel apparatus and process for regenerating hydrochloric acid within a spent hydrochloric acid pickle liquor used for pickling ferrous metals for reuse in the pickling line without the disadvantages characteristic of high temperature processes.

It is an object of the present invention to provide novel process and apparatus for regenerating the free hydrochloric acid within a spent hydrochloric acid pickle liquor used for pickling ferrous metals.

It is an object of the present invention to provide novel process and apparatus for regenerating the free hydrochloric acid within a spent hydrochloric acid pickle liquor used for pickling ferrous metals for reuse in the pickling line without the disadvantages characteristic of high temperature processes.

It is another object of the present invention to provide a process and apparatus for recovering ferrous chloride from a spent hydrochloric acid pickle liquor wherein the ferrous chloride may be efficiently removed from the spent pickle liquor and easily handled after removal.

It is another object of the present invention to provide a process and apparatus for the efficient closed-loop regeneration of a spent hydrochloric acid pickle liquor for ferrous metals for reuse in a pickling line.

It is another object of the present invention to produce ferrous sulfate heptahydrate from ferrous chloride.

It is an object of the present invention to provide a spent pickling liquor recovery process to be carried out at relatively low temperatures.

It is an object of the present invention to provide a spent pickling liquor recovery process economical to operate and less expensive than existing spent pickling liquor recovery plants.

These and other related objects and advantages of the present invention will become apparent from a careful inspection of the detailed description and the figures of the drawings which follow.

### SUMMARY OF THE INVENTION

The apparatus and process of the present invention provide means and method for regenerating a metal pickling process solution containing a metal salt of a first acid. A second acid is added to the metal pickling process solution to produce a regenerated first acid and a metal salt of the second acid. The metal salt of the second acid is crystallized, and removed from the solution. In one aspect, the apparatus and method of the present invention provide means and method for regenerating a ferrous metal pickling process solution containing ferrous chloride. Sulfuric acid is added to the solution to produce regenerated hydrochloric acid and ferrous sulfate. The ferrous sulfate is crystallized, and removed from the solution. In one aspect, the apparatus and method of the present invention provide for pickling a metal. A solution including a first acid contacts the metal for a time sufficient to provide pickling. The metal is removed from the solution, a second acid is added to the solution to produce a regenerated first acid and a metal salt of the second acid, and the metal salt of the second acid is crystallized, and removed from the solution. In one aspect, a second acid is added to the solution to produce a regenerated first acid and a metal salt of the second acid at a specified temperature. A mixture of first and second acid from regeneration can contact the metal with effective results.

The present invention provides novel process and apparatus for the closed-loop regeneration of spent hydrochloric acid pickle liquors used to pickle ferrous metals by recovering ferrous chloride from the spent pickle liquors at low temperatures. Ferrous sulfate heptahydrate crystals formed at low temperatures are removed from the pickle liquor, which then permits reuse of the free hydrochloric acid remaining within the regenerated pickle liquor in normal pickling operations. The low temperature, low energy requirements of the apparatus and processes of the invention make for economic superiority to high temperature closed-loop regeneration processes for spent hydrochloric acid pickle liquors, and allow the recycling of a much larger percentage of organic acid inhibitors present in spent pickle liquor.

In one aspect, the present invention provides apparatus and process for recovering spent hydrochloric acid pickling liquors used to pickle ferrous metals through a spent hydrochloric acid pickling liquor having sufficient amounts of free hydrochloric acid and iron to allow subsequent precipitation of ferrous sulfate heptahydrate crystals at low temperatures without freezing the pickling liquor; cooling the liquor to a temperature sufficiently low to cause ferrous sulfate heptahydrate crystals to form; and separating the precipitated ferrous sulfate heptahydrate crystals from the resultant supernatant.

In one aspect, the present invention provides apparatus and process for recovering a spent hydrochloric acid pickling liquor used to pickle ferrous metals by a first supply of spent pickle liquor, the first supply containing spent hydrochloric acid pickling liquor; a first container suitable for holding the spent pickling liquor; a valved conduit connecting the first container with the first supply for delivering spent pickling liquor from the first supply to the first container; refrigerating means including a refrigerating heat exchanger positioned in association with the first container for actively cooling spent pickling liquor within the first container to a temperature sufficiently low to cause ferrous sulfate heptahydrate crystals to form; agitating means to cause the spent pickling liquor to flow within the first container while being actively cooled; and separating means for separating precipitated ferrous sulfate heptahydrate crystals from the resultant supernatant.

### BRIEF DESCRIPTION OF THE DRAWINGS

FIG. 1 is a flow diagram of the present invention.

FIG. 2 is a schematic flow diagram of apparatus and process for regenerating spent hydrochloric acid pickle liquor according to the present invention for treating steel from a continuous steel strip mill.

FIG. 3 is a schematic flow diagram of apparatus and process for regenerating spent hydrochloric acid pickle liquor and the crystallization of ferrous sulfate in a separate crystallizer according to the present invention.

FIG. 4 is a graph of the solubility of ferrous sulfate in hydrochloric acid as a function of temperature.

### DETAILED DESCRIPTION

The present invention provides novel apparatus and method for pickling iron and steel in combination with the on-site regeneration of the pickling acid from the metal salt resulting from the pickling.

The present invention provides apparatus and process for pickling the steel in a solution of hydrochloric acid with some ferrous sulfate. The solution at the completion of pickling contains ferrous chloride with some ferrous sulfate and residual hydrochloric acid. The solution at the completion of pickling is fed to a chilled reactor where concentrated sulfuric acid is added, sufficient to react with the ferrous chloride.

When additional sulfuric is added to the pickling acid being regenerated so that a “mixed acid” is returned to the pickling tank, several benefits occur. The solubility of the ferrous sulfate is further depressed so that additional ferrous sulfate is crystallized and removed. This reduces the iron in the acid returning to the pickling tank and reduces the amount of acid needed to be recirculated. Also, when this added acid value from the sulfuric acid is used to replace the equivalent amount of hydrochloric acid, the same efficacy of pickling results, but there is a lowering of the concentration and thereby the vapor pressure of HCl in the hot pickling tank.

In an example of a reduction of the hydrochloric acid by 2%, replacing the acid value by sulfuric acid, there is a reduction of vapor pressure of HCl over the range of the pickling tank of an average of 50%. This causes the loss of HCl vapor to the scrubbing system to be reduced by 45-50%, thereby saving considerable loss of hydrochloric acid. Losses from vaporization are dropped from 10% ro 5% of the HCl returned to the pickling tank.

The resultant solution is chilled to 0-35° F., facilitating the crystallization of ferrous sulfate heptahydrate. The ferrous sulfate heptahydrate crystals are removed from the solution. The remaining solution is heated, its concentration adjusted, with water, and recycled to the pickling tank as fresh pickling acid. The ferrous sulfate heptahydrate is dewatered and sold as a by-product.

The present invention produces ferrous sulfate heptahydrate and hydrochloric acid from ferrous chloride or liquors containing ferrous chloride. In one aspect, the present invention produces ferrous sulfate heptahydrate and hydrochloric acid from ferrous chloride or liquors containing ferrous chloride produced in the production of steel or from other industries.

The present invention regenerates spent pickle liquors. In aspect, the present invention regenerates spent hydrochloric acid pickle liquors used for ferrous metal pickling by recovering ferrous chloride from the spent pickle liquors at low temperatures.

We have found empirically that the present invention operates at a preferred temperature of addition of sulfuric acid. We have found empirically that the present invention operates at a preferred temperature for the crystallization of the ferrous sulfate heptahydrate.

We have found empirically that the present invention operates to form ferrous sulfate heptahydrate, having seven (7) molecules of water.

The apparatus and process of the present invention operate through the steps of (1) providing a waste acid of HCl and adding a second acid of H₂SO₄; (2) providing a preferred critical temperature; (3) chilling to form ferrous sulfate heptahydrate; (4) removing crystals; and (5) obtaining HCl.

The apparatus and process of the present invention add sulfuric acid to cover iron sulfate heptahydrate.

Conventional practice calls for process which regenerates a pure HCl. The economics of a conventional regeneration system include flashing the HCl and cooling subsequent to and tied to the flashing. The apparatus and process of the present invention operate to have sulfate and iron present and not need to go through the difficulty and energy expense and to get all the iron out of the system. The apparatus and process of the present invention operate not to go across a large phase transition from liquid to vapor. The apparatus and process of the present invention operate to have a phase transition from liquid to crystal from 90° F. down to 35-0° F., not 90° F. to 600° F., providing a significant energy savings. The apparatus and process include a low energy phase change, namely crystallization compared to a high energy phase change, namely vaporization and condensation. The apparatus and process of the present invention operate to go across crystallization of ferrous salt, providing a significant energy advantage.

The apparatus and process of the present invention operate to save energy, use less equipment, require less capital, and operate with low flows.

Conventionally, one would not make contaminated HCl. One would not make HCl for pickling regeneration without first taking out the sulfates and iron.

In the history of steel making, H₂SO₄ was used for pickling, through controllable processes, but over slower times and lower amounts of ferrous. With increased production levels, steel making went to HCl and not to mixed sulfuric acid and hydrochloric acids.

The apparatus and process of the present invention operate to tolerate some sulfuric, even providing a benefit because the sulfuric reduces HCl loss from vaporization. The apparatus and process of the present invention operate to include iron in the pickling feed also. This inclusion of a small amount of iron activates the pickling of the initial acid.

In this way, the apparatus and process of the present invention operate to regenerate HCl by adding H₂SO₄ and crystallizing.

We have found empirically that the present invention operates at a preferred critical temperature. If the temperatures are too high or too low, the process does not operate to specification. At the preferred temperature, the kinetics of the process operate to specification. If too hot, the crystallize step will not operate to specification, and too much iron will be left in solution. If too cold, ice crystals will form and dilute the ferrous sulfate heptahydrate product.

We have found empirically that the present invention operates at a preferred critical temperature, including a controlled bath of 30-45° F. for adding H₂SO₄, preferably at different times.

We have found empirically that the present invention operates in a way to form the sulfate hydrate properly and crystallize it properly. We have found empirically that the present invention operates in balancing H₂SO₄, 2H+ and Cl ions, sulfate ions, and Fe ions. We have found empirically that the present invention operates to break weakly associated FeCl2 and form strongly associated FeSO₄, at the right temperatures.

We have found empirically that the present invention operates in mixing sulfuric acid with spent hydrochloric acid at a certain temperature and forming FeSO₄ capable of being crystallized by temperature reduction at a specific temperature to 0-35 degrees F.

According to the present invention, the amount of sulfuric acid also is important to balance the sulfate with the iron, to manage the hydrogen ions, to add enough sulfate, and to form and remove FeSO₄. Adding excess SO₄ ions reduces Fe solubility and HCl vaporization.

Preferably, the process of the present invention allows the reduction of the Fe to 4 grams/100 ml solubility. The process preferably does not remove too much sulfate or allow too much sulfate in the recovered acid, but some sulfate in the recovered acid is not a problem in recycling operations, e.g., 13% HCl and 1% H₂SO₄, where the H⁺ ions stay in solution to provide HCl, and the Fe goes with SO₄ as FeSO₄ and is removed.

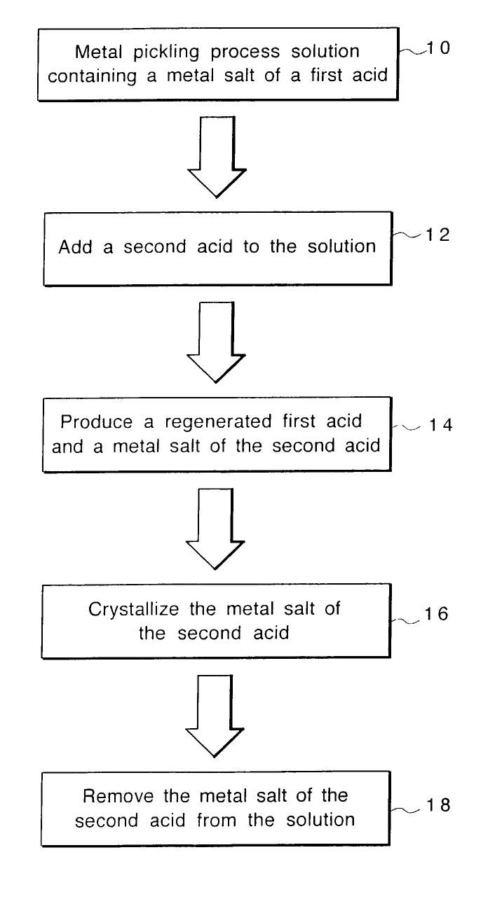

Referring now to FIG. 1, the present invention for regenerating a metal pickling process solution is shown by reference numeral 1 in the flow diagram of FIG. 1. A metal pickling process solution 10 contains a metal salt of a first acid. The first acid preferably is hydrochloric acid. The first acid can be nitric acid, hydrofluoric acid, or a halogen acid. The metal pickling process solution 10 is referred to as spent pickle liquor (SPL). The metal pickling process solution 10 is regenerated with a second acid. The second acid is added to the spent pickle liquor (SPL) 12, producing a regenerated first acid and a metal salt of the second acid 14. The metal salt of the second acid is crystallized 16 and removed from the solution 18.

The second acid of the present invention reacts with the metal salt of the first acid to form a metal salt of the second acid. The metal salt of the second acid then is crystallized. The second acid has a higher affinity for the metal than the first acid, and the reaction equilibrium favors the formation of the metal salt of the second acid. The metal salt of the second acid is less soluble than the metal salt of the first acid for crystallization. The second acid does not produce by-products detrimental to the pickling process.

For example, in one embodiment of the method of the invention, the first acid is hydrochloric acid and the metal is iron or steel. In the hydrochloric acid pickling of iron or steel, the acid reacts with the scale on the metal as shown in Equations 1-3.

Fe₂O3+Fe+6HCl=3FeCl₂+3H₂O Equation 1

Fe₃O₄+Fe+8HCl=4FeCl₂+4H₂O Equation 2

FeO+2HCl=H₂O+FeCl₂ Equation 3

The spent pickle liquor (SPL) from a hydrochloric acid pickling process of iron or steel contains ferrous chloride as the metal salt of the first acid, though the iron stays in solution in the hydrochloric acid as ferrous ion (Fe²⁺).

In one embodiment, the second acid is sulfuric acid, and the metal salt of the second acid is ferrous sulfate. In an aqueous solution, ferrous sulfate forms ferrous sulfate heptahydrate. Sulfuric acid has a higher affinity for iron than hydrochloric acid. The acid reacts with ferrous chloride as shown in Equation 4.

FeCl₂+H₂SO₄=FeSO₄+2HCl Equation 4

The solubility of ferrous sulfate heptahydrate in hydrochloric acid is lower than the solubility of ferrous chloride. The lower solubility provides the ferrous sulfate to be crystallized more readily than ferrous chloride.

The second acid is added to the spent pickle liquor (SPL) in a manner providing adequate mixing and other process conditions to react the metal salt of the first acid and the second acid to form the metal salt of the second acid. For example, the second acid and the spent pickle liquor (SPL) are reacted in an apparatus of the present invention, including a reactor vessel or in-line mixing apparatus. The reaction of the second acid and the spent pickle liquor (SPL) are reacted in a reactor vessel. The reactor vessel is of a type or configuration facilitating the reaction between the metal salt of the first acid and the second acid. For example, the reactor vessel includes means and method for providing agitation or static mixing. The reactor vessel is run under process conditions to allow the reaction between the metal salt of the first acid and the second acid. The process conditions are controlled to drive the reaction toward completion. For example, the production of ferrous sulfate from sulfuric acid and ferrous chloride is promoted by cooling. The sulfuric acid is added to the spent pickle liquor (SPL) containing the ferrous chloride in a chilled reactor vessel. The reactor vessel is cooled down to temperatures to promote the reaction and to prevent the formation of unwanted byproducts. The preferred temperature of the reactor vessel is determined by the required degree of regeneration and the cost of power and capital for refrigeration. For example, in the regeneration of hydrochloric acid from a ferrous metal pickling process with sulfuric acid, the reactor is cooled down to minimize the oxidation of Fe²⁺ to Fe³⁺. Fe³⁺ forms ferric sulfate with sulfuric acid rather than ferrous sulfate. Ferric sulfate is more soluble that ferrous sulfate, and more difficult to remove from the regenerated first acid. A temperature between about 0° F. and about 65° F. is used.

Following the addition of the second acid, the metal salt of the second acid is removed from the regenerated first acid. The metal salt of the second acid is crystallized to provide separation of the metal salt of the second acid from the regenerated first acid. The separation step is performed under process conditions favoring the crystallization of the metal salt of the second acid. Where cooler conditions promote the crystallization of the metal salt of the second acid, the step is carried out under cooled temperatures to promote the crystallization. The crystallization temperature is determined based on practical and economic factors, such as the maximum allowable iron concentration in the regenerated first acid and the cost of power and capital for refrigeration. For example, in the crystallization of ferrous sulfate heptahydrate, the crystallization is carried out at cooled temperatures to promote crystallization and to lower the iron content of the regenerated first acid. However, at lower temperatures, water forms ice crystals that are removed along with the ferrous sulfate heptahydrate crystals causing a high moisture content in the crystals and handling problems. The level of iron removal from the regenerated first acid and the presence of water in the crystals are balanced for the specific process.

For some metal salts of the second acid, crystallization is improved by the addition of other substances which lower its solubility. For example, the addition of sulfate ions decreases the solubility of ferrous sulfate. Accordingly, sulfate ions, for example, in the form of sodium sulfate, are added to the solution to improve crystallization. Sulfate ions also are introduced by adding greater than the stoichiometric amount of sulfuric acid, or by maintaining a residual level of sulfate ions in the pickling liquor.

Crystallization is carried out as the metal salt of the second acid is present. For example, crystallization occurs in the reactor vessel as the metal salt of the second acid is produced, or it occurs separately in a crystallizer. The use of a separate crystallizer is preferred where the reaction conditions are not the same as the crystallization conditions.

The crystallized metal salt of the second acid is removed from the regenerated acid by a method providing the regenerated acid in a form usable for its intended application. For example, removal of the metal salt of the second acid from the regenerated first acid is performed in a unit such as a filter or a particle separator. Following separation, the regenerated acid is treated further, if necessary, for its desired use. For example, the acid is heated, or the acid concentration is adjusted, or the acid is heated and its concentration adjusted. After separation and treatment, the regenerated acid is recycled to the metal pickling line as fresh pickling acid.

The metal salt of the second acid also is treated following separation. For example, residual water on crystals of the metal salt of the second acid are removed. The removal is accomplished, for example, in a dewatering process. Following treatment, the crystals are used or disposed.

Low residual concentrations of the metal salt of the second acid are possible after crystallization. Residual metal ions in the recovered acid, however, are useful, for example, in many iron or steel pickling processes. Crystallization reduces the presence of the non-metal ions of the metal salt of the second acid, such as sulfate for ferrous sulfate, such that the ions will not affect pickling significantly with the regenerated acid. For example, with crystallization, the amount of sulfate present in hydrochloric acid regenerated with sulfuric acid is reduced such that it will not affect pickling operations detrimentally. The preferred quantities of iron, hydrochloric acid, and sulfate ions in the regenerated hydrochloric acid are determined by the characteristics of the metal being processed and the preferred results of the pickling process.

In the operation of the apparatus and method of the present invention, heat is exchanged between flow streams. For example, the spent pickle liquor (SPL) from the pickling process and the regenerated acid fed to the pickling process exchange heat. For example, in processes where the metal salt of the first acid reaction with the second acid or the crystallization of metal salt of the second acid is promoted by cooler process conditions, the heat of the spent pickle liquor (SPL) is harnessed to reheat the regenerated acid prior to recycling. The spent pickle liquor (SPL) is cooled prior to the addition of the second acid or crystallization. The heat exchange is performed by a cross-flow heat exchanger such that the spent pickle liquor (SPL) exchanges heat with the regenerated first acid returning to the pickling process. The cross-flow heat exchange device or method, or other heat exchange device or method, uses a cooling or warming media to adjust further the temperature of the spent pickle liquor (SPL) or the regenerated acid.

The present invention is illustrated further by the following actual examples.

### EXAMPLE I

Actual experiments were conducted to investigate the crystallization of ferrous sulfate and solubility equilibrium for ferrous sulfate as a function of temperature. The experiments were conducted in a solution of 15.5 grams hydrochloric acid per 100 ml (15.5 wt. %/vol) at solution temperatures of 4.6° F., 10° F., 20° F., and 65° F. The concentration of sulfate ion was increased to investigate the effect on the solubility of iron. Sufficient Na₂SO₄ was added to the solution to bring the concentration of SO⁴⁻ in the solution to 4 grams per 100 ml.

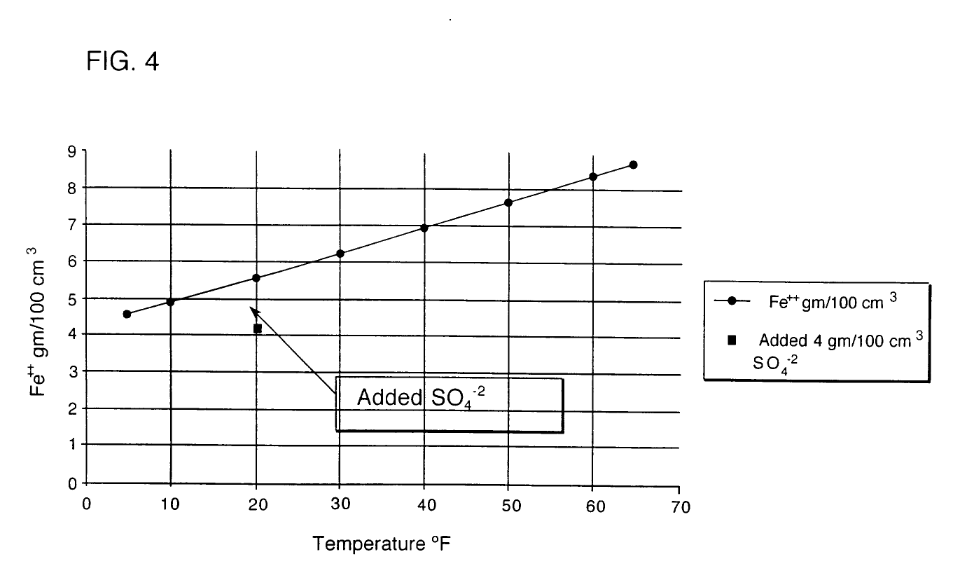

The results of the experiments are illustrated graphically in FIG. 4, in which the x-axis is temperature (° F.) and the y axis is the concentration of iron ions (Fe²⁺) in grams per 100 ml of solution. The curve of the solubility of iron ions as a function of temperature has a positive slope, demonstrating that iron is less soluble at lower temperatures and, thus, more ferrous sulfate will crystallize at such temperatures. At 20° F., the solubility of iron in hydrochloric acid is 5.5 grams per 100 ml of solution. The addition of sodium sulfate reduced the solubility to 4.1 grams per 100 ml, demonstrating that the addition of sulfate ions reduces further the solubility of iron.

### EXAMPLE II

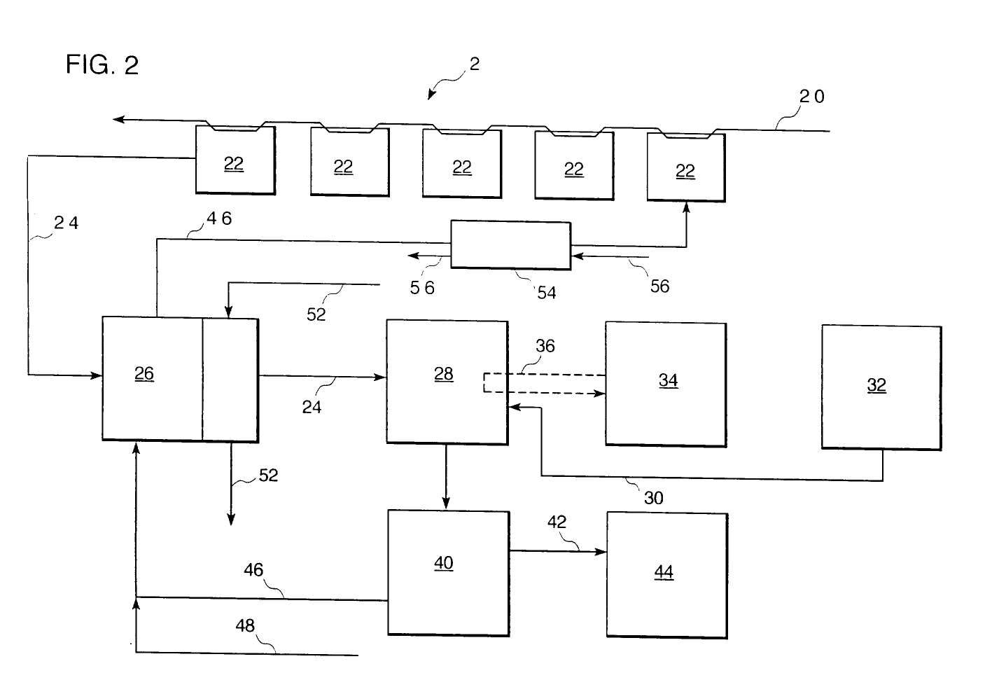

A material balance was performed on a pickling process including regeneration and recycle of the spent pickle liquor (SPL) from the process. A complete spent pickle liquor (SPL) regeneration apparatus and process 2 of the present invention are illustrated in a schematic process flow diagram FIG. 2.

Steel sheet 20 was fed continuously to a series of hydrochloric acid-based pickling baths 22. From the pickling baths 22, spent pickle liquor (SPL) containing about 0.15 pounds per gallon hydrochloric acid, about 0.89 pounds per gallon ferrous sulfate, and about 2.32 pounds per gallon ferrous chloride at about 170° F. flowed at a rate of about 100 gallons per minute into an spent pickle liquor (SPL) line 24. The spent pickle liquor (SPL) in line 24 flowed through a heat exchanger 26 where it was cooled by regenerated hydrochloric acid flowing at about 32° F. in line 46 and water flowing at about 50° F. in a line 52, reducing the temperature of the spent pickle liquor (SPL) to about 60° F. The cooled spent pickle liquor (SPL) then flowed from line 24 into a reactor vessel 28. About 93.5 weight percent (0.66° Be) sulfuric acid flowing at about 70° F. via a line 30 from storage vessel 32 then was added to reactor vessel 28 at a rate of about 15 gallons per minute.

Reactor vessel 28 included a heat exchanger which received coolant from a chiller 34 via a cooling line 36. Reactor vessel 28 and its contents were maintained at about 32° F. In reactor vessel 28, the ferrous chloride in the spent pickle liquor (SPL) reacted with the sulfuric acid, producing ferrous sulfate and regenerated hydrochloric acid. The ferrous sulfate was crystallized in the form of ferrous sulfate heptahydrate crystals in reactor 28. An outlet line 38 carried a solution containing about 1.49 pounds per gallon hydrochloric acid, about 0.89 pounds per gallon ferrous sulfate in solution, and 5.08 lb/gallon of ferrous sulfate heptahydrate crystals from reactor 28 at a flow rate of 115 gallon per minute.

Outlet line 38 fed the regenerated hydrochloric acid, ferrous sulfate heptahydrate crystals, and ferrous sulfate into a dewatering unit 40. In dewatering unit 40, ferrous sulfate heptahydrate was separated from the regenerated hydrochloric acid. The ferrous sulfate heptahydrate was sent to a ferrous sulfate heptahydrate line 42 at a rate of about 508 pounds per minute. The ferrous sulfate heptahydrate in line 42 passed to shipping 44 where it was packaged.

The regenerated hydrochloric acid solution, containing about 1.49 pounds per gallon hydrochloric acid and about 0.89 pounds per gallon ferrous sulfate, flowed into line 46 at a rate of about 83 gallons per minute. The regenerated hydrochloric acid solution flowed through line 46 to a mixing point where water at about 50° F. flowed from a water line 48 was mixed with the acid. The water brought the flow rate of the regenerated hydrochloric acid solution to about 100 gpm. The regenerated acid in line 46 then passed through heat exchanger 26 where the regenerated hydrochloric acid solution exchanged heat with the spent pickle liquor (SPL) in line 24, increasing its temperature to about 140° F. Line 46 then passed through a second heat exchanger 54 where the regenerated hydrochloric acid solution exchanged heat with steam in line 56, increasing its temperature to about 170° F. or higher. The regenerated acid solution was returned to pickling baths 22 via line 46.

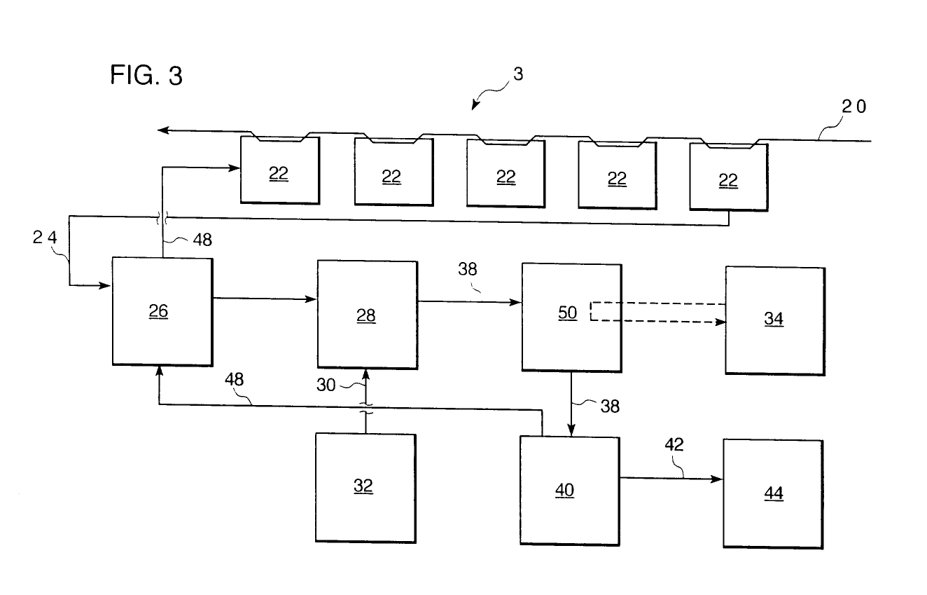

FIG. 3 illustrates apparatus and process 3 of the present invention wherein the crystallization of the ferrous sulfate occurred in a separate crystallizer 50.

A novel apparatus and process of the present invention provide a zero-discharge process for regenerating the hydrochloric acid in spent pickle liquor (SPL.) The novel apparatus and process of the present invention regenerate hydrochloric acid spent pickle liquor (SPL). The process uses sulfuric acid to produce ferrous sulfate heptahydrate from the ferrous chloride in the SPL, leaving a solution with a restored concentration of the hydrochloric acid suitable for recycling to the pickle tub. The ferrous sulfate crystals are a product in demand, resulting in zero discharge. As a byproduct of the process, ferrous sulfate crystals are sold. The process generates no wastewater or residual waste requiring disposal. The novel apparatus and process of the present invention provide significant operating and capital cost savings

Spent hydrochloric acid pickling liquor (SPL) in the steel rolling and finishing industry contains 25 to 30 wt. % ferrous chloride and 0.5 to 2 wt. % hydrochloric acid. Approximately 1.5 billion gallons of spent pickle liquor are produced annually in U.S. integrated mills and by outside processors. Over 90% is from HCl pickling lines. The principal acid regeneration process is the acid spray roasting process, which converts the SPL to a distilled hydrochloric acid of approximately 18%, plus a fine iron oxide dust. The iron oxide is used for manufacturing magnetic products, and otherwise, it is discarded. The spray roasting process has many disadvantages, including the large size, high capital cost, and high operating cost required for regenerating the acid.

The novel apparatus and process of the present invention use a metal salt of a second acid having a solubility in a first acid, e.g., of hydrochloric acid lower than ferrous chloride. In one aspect, by adding sulfuric acid to a ferrous chloride solution and chilling the solution, ferrous sulfate heptahydrate is crystallized, removing iron from the solution together with sulfate introduced with the sulfuric acid. The hydrochloric acid thereby is regenerated and is recycled to the pickling line to form a continuous processing loop.

The by-product ferrous sulfate heptahydrate is a valuable commodity in short supply in the United States and is sold. The novel apparatus and process of the present invention does not generate any wastewaters or other residual wastes requiring additional treatment or disposal. The novel apparatus and process of the present invention provide a zero discharge process having significant environmental advantages for facilities currently sending SPL off site for disposal.

Hydrochloric acid is used to pickle hot rolled or heat-treated carbon steel sheet, rod, and wire. Many steel producers prefer hydrochloric acid because of the speed of pickling and the uniform surface characteristics in continuous pickling operations.

Operating conditions for batch pickling in hydrochloric acid involve acid concentrations from 8-12 g/100 ml, temperatures of 100 to 110° F., and immersion times from 5 to 15 minutes with a maximum allowable iron concentration of 13 g/100 ml. Operating conditions for continuous pickling in hydrochloric acid solution typically involve acid concentrations of 2-20 g/100 ml, temperatures of 150-200° F., and immersion times of 1 to 20 minutes.

Hydrochloric acid offers a number of advantages when compared with sulfuric or other acids. Effective pickling is obtained with iron concentrations as high as 13 g/100 ml. Acid is used until the free acid concentration is as low as 1-2 wt. %, or lower in the galvanizing industry where it is used to strip zinc.

In contrast, sulfuric acid pickling is rarely used above iron concentrations of 8% or acid concentrations below 6%. Sulfuric pickling operations benefit from acid recovery by purifying the pickling acid through the low temperature crystallization of ferrous sulfate heptahydrate. The crystals are separated and sold as a useful product, and the purified acid is recycled to the pickling tank.

In the case of hydrochloric acid, essentially no acid is left to recover, and the ferrous chloride is extremely soluble. Ferrous chloride is not as easily crystallized as ferrous sulfate. Since recycling residual traces of acid is not economically feasible, the SPL either has been “sold” to water treatment facilities for the ferrous chloride value, regenerated to iron oxide and 18% hydrochloric acid by the spray roasting process, treated in a wastewater treatment plant, or deep well injected.

The acid regeneration process of the present invention, as it would be installed on a continuous strip mill, is illustrated in FIG. 1.

Steel is fed continuously through a series of pickling tanks. Acid exits from the pickling line at approximately 13% iron and 1-2 wt. % hydrochloric acid. The temperature of the exiting acid is approximately 190° F.

Using a cross-flow heat exchanger, the exiting acid exchanges heat with the acid returning to the system. The acid to be regenerated then flows into a reactor where it is contacted with 66° Be (93 wt. %) sulfuric acid.

The reaction mix is chilled to temperatures of 0-35° F. in a crystallizer. Because of the limited solubility of ferrous sulfate heptahydrate in acid solutions, it precipitates, crystallizes, effectively removes the majority of the iron and sulfate, leaving behind hydronium ions from the sulfuric acid and the chloride ions from the ferrous chloride. Depending on the crystallization conditions, more or less Fe⁺⁺ and SO₄⁺⁺ ions return with the recycling acid. The regenerated acid is recycled as essentially hydrochloric acid.

The by-product of the process is marketable ferrous sulfate heptahydrate, which is separated from the regenerated acid by a suitable filter or centrifuge.

Actual experimental work on the physical chemistry and the reaction rates of the process of the present invention were conducted on the solubility of iron in hydrochloric acid at various concentrations and temperatures with mixtures of sulfuric acid. Regeneration experiments were conducted with spent hydrochloric acid from a large continuous pickling line. Hydrochloric acid was successfully regenerated, and ferrous sulfate crystals recovered.

The process and apparatus of the present invention operate on a difference in the solubility of ferrous sulfate and ferrous chloride in acid to provide the preferred separation of the present invention possible. In terms of a comparative solubilities of these salts in their respective acids, as the sulfuric acid regenerates hydrochloric acid, the solubility of the iron is repressed, and the iron is driven out of solution as ferrous sulfate. Significantly low residual concentrations of iron and residual sulfate are possible.

A residual amount of iron in the returning pickling bath is not a disadvantage. Many pickling operations prefer some residual metal to totally fresh acid.

Actual experimental work generated solubility equilibrium data for ferrous sulfate at a specific hydrochloric acid concentration. A decreasing solubility of ferrous ions in 15.5 g HCl/100 cc, (15.5%o wt/vol) by increasing the concentration of sulfate ions was illustrated by the addition of 4 g/100 cc SO⁴⁺ using Na₂SO₄. At 20° F., the iron in the hydrochloric acid was reduced to 5.5 g/100 cc. Sodium sulfate then was added to demonstrate the further reduction in solubility caused by the addition of sulfate ions. The solubility was reduced to 4.1 g/100 cc. Sulfate ions also are introduced into the reactor by adding more than stoichiometric sulfuric acid or by maintaining a residual level of sulfate ions in the pickling bath.

The level at which to maintain iron, hydrochloric acid, and sulfate ions in the regenerated hydrochloric acid relates to the metal being processed and the results preferred from the pickling operation.

The comparative economics of pickling operations using fresh hydrochloric acid or hydrochloric acid regenerated with sulfuric acid are a function of a comparative cost of acid to remove scale, net savings of the recovery process, cost of disposal of SPL vs. income from sales of ferrous sulfate crystals, operating costs, including power, labor, and maintenance, and capital cost Comparative cost of acid to remove scale.

Hydrochloric acid purchased in bulk at 32 wt. % acid has a delivered price of $145-180 per ton, depending on the area of delivery. The equivalent 100% (anhydrous) price for hydrochloric acid is $453-563 per ton. Sulfuric acid prices have a wider variation. On a 100% basis, the bulk delivered price of sulfuric acid is $48-110 per ton.

Hot rolled steel has a scale of 0.000228-0.000380 inch thickness. The theoretical dosage of hydrochloric acid to remove the scale is 9.03 lb of anhydrous HCl or 13.9 lb of 66° Be (93.5 wt. %) sulfuric acid per 1,000 square feet of surface. Strip 0.09 inch thick has 1,086 sq.ft./ton. Heavier gauge sheet has proportionally less surface area and requires proportionally less acid per ton. Table 1 shows the comparative acid cost for pickling with fresh hydrochloric acid as compared to pickling with hydrochloric acid regenerated from sulfuric acid.

TABLE 1
Comparative Raw Material Cost for Pickling Hot Rolled Strip

| | $/M sq. ft. | $/ton of 0.09″ Strip |
|---|---|---|
| Process | Pickled | (1086 sq. ft./ton) |
| Fresh hydrochloric acid | $1.88-2.33 | $1.73-2.15 |
| Hydrochloric acid | $0.33-0.76 | $0.30-.70 |
| regenerated on site | | |
| with sulfuric acid | | |
| Net savings | $1.55-1.57 | $1.43-1.45 |

In terms of the net savings of the recovery process, the cost of the raw materials is important, but another significant benefit accrues from selling the by-product ferrous sulfate heptahydrate crystals rather than paying for hauling away the spent pickle liquor.

The cost for hauling away spent pickle liquor is $0.60/gal, and is in the range of $0.20 to $1.00/gal in some locations. Acid removal costs $3.36/Mft² pickled, with a range from $1.162-5.60/Mft².

The revenue from the sale of most by-product ferrous sulfate heptahydrate ranges from $15-65/ton, providing a revenue of $0.33-$1.41/Mft².

Table 2 summarizes the potential savings using regenerated acid.

TABLE 2
Savings from Raw Material Purchases and By-Product Sales
$/M sq. ft. Pickled

| | Budget | Min. | Max. |
|---|---|---|---|
| Acid purchases Sulfuric vs. Hydrochloric | 1.56 | 1.55 | 1.57 |
| Acid disposal/hauling cost | 3.32 | 1.11 | 5.53 |
| Crystal sales revenue | 0.43 | 0.33 | 1.41 |
| Power cost | .24 | | |
| Labor cost | .19 | | |
| Total Savings and Revenue | $4.71 | $2.39 | $8.08 |

A savings is provided of $4.35/ton for 0.09 inch strip. Savings for heavier gauges are proportionally less.

The savings are $3,679/day. for a mill that formerly generated 5,000 gallons per day of SPL containing 13 g Fe/100 cc by pickling 781 Mft² day.

The operating cost for the apparatus and process of the present invention includes power, operators, and maintenance. The power cost is linear and is $0.24/ft² pickled. Operator labor and maintenance costs are $0.19/Mft².

The capital cost for the process equipment does not vary linearly with capacity to regenerate acid, but rather there is a substantial economy of scale. The larger the facility, the lower the amortized cost per 1,000 square feet of steel pickled. The capital cost of the facility generally follows the relationship as shown in Equation 5.

C₂=(R₂/R₁)^{Z}×C₁ Equation 5

Where:

C₁=Cost of base facility rated for R₁ tons Fe removal/day,

C₂=Cost of base facility rated for R₂ tons Fe removal/day, and

Z=exponent factor ranging 0.6-0.7.

The apparatus and process of the present invention provide attractive paybacks for even the smallest mills. In some cases, paybacks occur at less than one year.

The apparatus and process of the present invention provide substantial positive energy and environmental effects. Delivering sulfuric acid instead of hydrochloric acid requires fewer trucks and saves fuel, reduces the generation of greenhouse gas, and minimizes exposure of the environment to potential accidental spills. The energy cost for manufacturing sulfuric acid is less than that for hydrochloric acid, saving both energy and greenhouse gases.

The apparatus and process of the present invention replace the practice of regenerating SPL at an off-site roasting facility. The on-site chemical regeneration saves fuel, reduces the generation of greenhouse gasses, and minimizes incidents of exposure of the environment to potential accidental spills. The energy cost of regenerating hydrochloric acid with sulfuric acid is less than that of regenerating hydrochloric acid by the roasting process, saving energy and reducing greenhouse gases.

The apparatus and process of the present invention replace deep well injection and replace the treatment of acid and subsequent landfill of treated waste sludge, for a significant environmental advantage because it produces marketable ferrous sulfate heptahydrate, rather than a waste. Ferrous sulfate crystals are used in several industries and are imported in large quantities from Europe.

The present invention provides novel apparatus and method for pickling iron and steel in combination with the on-site regeneration of the pickling acid from the metal salt resulting from pickling.

The present invention provides apparatus and process for pickling the steel in a solution hydrochloric acid with some ferrous sulfate. The solution at the completion of pickling contains ferrous chloride with some ferrous sulfate and residual hydrochloric acid. The solution at the completion of pickling is fed to a chilled reactor where concentrated sulfuric acid is added, sufficient to react with the ferrous chloride.

The resultant solution is chilled to 0-35° F., facilitating the crystallization of ferrous sulfate heptahydrate. The ferrous sulfate heptahydrate crystals are removed from the solution. The remaining solution is heated, its concentration adjusted, with water, and recycled to the pickling tank as fresh pickling acid. The ferrous sulfate heptahydrate is dewatered and sold as a by-product.

The present invention regenerates hydrochloric acid from the spent pickle liquor resulting from steel pickling. The present invention provides many benefits, including significant energy savings, the ability to perform on-site closed-loop pickling and regeneration, the elimination of transport and off-site processing of hazardous spent pickle liquor, the availability of a cost-effective regeneration system for very small mills, and many cost and resource savings associated with all of these improvements. The present invention provides a profound impact on energy use, pickling costs, and pollution generation throughout the steel industry.

The present invention regenerates spent hydrochloric acid from steel pickling, that results in approximately 95% energy savings, 52% cost savings, and 91% reduction in CO2 over conventional technologies. The process generates no wastewater or residual waste requiring disposal and results in significant operating and capital cost savings in addition to major energy savings. The technology uses sulfuric acid to produce ferrous sulfate heptahydrate from the ferrous chloride in spent pickle liquor, leaving a solution with a restored concentration of the hydrochloric acid suitable for recycling to the pickle tub. Ferrous sulfate crystals, a by-product, is sold for reuse.

Spent pickle liquor (SPL) is an EPA listed hazardous waste (waste category K062) requiring costly and energy intensive handling, treatment, and disposal. Eighty percent (80%) of SPL is sent to publicly owned treatment works (POTWs) or regenerated; approximately 20% is neutralized and landfilled or disposed by deep well injection. The SPL sent to POTWs and treatment plants contains acid that must be neutralized with lime or caustic, requiring the use of energy and raw materials.

The most common method of regeneration is an acid spray roasting process that requires high investment, significant energy use, and produces a waste ferric oxide dust. A 40,000-gallon/day SPL roasting process plant costs approximately $7 million and uses 1.8×10¹¹ BTU/year (See Table 3). The roasting process is uneconomical for small quantities of SPL. Smaller pickling mills, e.g., 80% of U.S. pickling mills, either ship their SPL by tank trucks to central processing plants at distances of up to several hundred miles, and then the regenerated acid is shipped back, or they ship to a POTW and receive shipments of fresh acid. The transport involves significant cost, fuel consumption, and exposure of the public and the environment from the transport of hazardous materials.

Actual experimental work was conducted on spent pickling solution from an operating steel mill. The spent pickling solution was treated with sulfuric acid and chilled, resulting in the crystallization and recovery of ferrous sulfate heptahydrate. Tests were run at different acid concentrations and different temperatures. The solutions were analyzed for iron, acid, chloride and sulfate ions. Based on these tests, optimal acid concentrations and operating conditions have been identified.

The present invention (1) saves 230,000 BTU per ton of steel pickled compared to the conventional roasting process; (2) enables on-site closed loop pickling and regeneration, eliminating the need for transport of SPL and regenerated acid and off-site processing, saving 179,000 BTU/ton of steel; (3) is cost effective for very small mills for which regeneration has been prohibitively expensive in the past; (4) produces a marketable by-product (ferrous sulfate heptahydrate) in short supply in the U.S. rather than a waste or unmarketable substance; (5) uses the preferred hydrochloric acid in the pickling process, and (6) uses less costly concentrated sulfuric acid at approximately ⅓ of the volume of HCl required from the conventional roasting process

The closed loop regeneration of the present invention proceeds indefinitely with additions of fresh HCl required only to make up for drag-out.

The present invention provides energy savings for a 40,000-gallon/day SPL plant of 2.96×10¹¹ BTU/year, which includes savings from both processing and transport energy. This equates to an estimated 91% savings in energy use over the existing roasting technology.

The present invention provides environmental (waste) savings. The projected annual energy savings for a 40,000-gallon/day SPL plant are 10,621 tons of CO₂ based on energy production and transportation emissions. This equates to an estimated 91% savings in waste generation over the existing roasting technology. See Table 3 below for a summary of cost, energy, and environmental savings.

The present invention provides economic benefits for pickling with regenerated hydrochloric acid in a 52% cost saving over pickling using fresh hydrochloric acid, as summarized in Table 3.

TABLE 3
Annual Energy, Cost, and Waste Savings for 40,000
gallon/day SPL HCl Recovery Plant 730,000 TPY steel.

| | Current roasting | | |
|---|---|---|---|
| | technology | Present Invention | Savings |
| Plant | $8 million | $1.5 million | (amortized |
| Cost | (amortized | (amortized | 7 yr @ 6%) |
| | 7 yr @ 6%) | 7 yr @ 6%) | |
| | $1,402,421/yr | $262,953/yr | $1,139,468/yr |
| Process | 1.83 × 10¹¹ | 1.69 × 10¹⁰ | 1.66 × 10¹¹ |
| energy | BTU/year | BTU/year | BTU/year |
| | $2,688,000/yr | $204,400/yr | $2,483,600 |
| Transport | 1.1 million gallons | $42,000/yr | 1.1 million gallons |
| energy | fuel/year | For fresh sulfuric | fuel/year |
| | $1,314,000/year | acid | $1,314,000/year |
| | 1.3 × 10″ BTU/yr | | 1.3 × 10″ BTU/yr |
| Raw | $548/ton of | $91/ton of | $3,300,000/yr |
| materials | dissolved iron for | dissolved iron for | |
| (Fresh | virgin HCl, | sulfuric acid | |
| Basis) | $4,000,000/yr | $700,000/yr | |
| CO₂ from | 11,680 tons of CO₂ | 1,059 tons of CO₂ | 10,621 tons of CO₂ |
| energy | | | |
| and | | | |
| transport | | | |
| Un- | cost of trucks and | | |
| accounted | drivers for transport; | | |
| savings | waste ferric oxide | | |
| | dust disposal | | |

| | |
|---|---|
| TOTAL SAVINGS | $4.93 million |
| | 2.96 × 10¹¹ BTU/yr |
| | 10,621 tons of CO₂/year |

These savings result primarily from comparative cost of acid to remove scale. The acid cost of pickling with fresh HCl compared to that of pickling with HCl regenerated from sulfuric acid results in a net savings of approximately $1.55 per thousand square foot pickled or $1.45 per ton for 0.09″ strip. The net savings of the recovery process include the estimated savings from raw material purchases H₂SO₄ vs. HCl and by-product sales of ferrous sulfate heptahydrate crystals are $4.35 per ton for 0.09″ strip. the capital cost of a 40,000 gallon/day apparatus and process of the present invention is $1.5 million compared to an estimated $7 million for a roasting process plant.

It will be understood that each of the elements described herein, or two or more together, may be modified or also may find utility in other applications differing from those described above. While particular embodiments of the invention have been illustrated and described, it is not intended to be limited to the details shown, since various modifications and substitutions may be made without departing in any way from the spirit of the present invention as defined by the following claims.

What is claimed is:

1. A method of regenerating a metal pickling process solution containing a metal salt of a first acid, comprising:
a) providing a metal pickling process solution containing a metal salt of a first acid;
b) adding a second acid to said solution to produce a regenerated first acid and a metal salt of said second acid;
c) crystallizing said metal salt of said second acid; and
d) removing said metal salt of said second acid from said solution.

2. A method as set forth in claim 1, wherein said first acid is hydrochloric acid and said metal salt of said second acid is ferrous sulfate heptahydrate.

3. A method as set forth in claim 2, wherein said adding a second acid to said solution comprises adding said second acid at a temperature lower than 65 degrees F.

4. A method as set forth in claim 2, wherein said adding a second acid to said solution comprises adding said second acid at a temperature lower than 40 degrees F.

5. A method as set forth in claim 2, wherein said adding a second acid to said solution comprises adding said second acid at a temperature in the range of 0 degrees F. to 40 degrees F.

6. A method as set forth in claim 1, wherein said first acid is hydrochloric acid.

7. A method as set forth in claim 3, wherein said second acid is sulfuric acid.

8. A method as set forth in claim 1, further comprising the step of decreasing the solubility of said metal salt of said second acid.

9. A method as set forth in claim 1, wherein said second acid is added in excess of the stoichiometric amount.

10. A method as set forth in claim 1, further comprising the step of recycling the regenerated first acid to the metal pickling process.

11. Apparatus for regenerating a metal pickling process solution containing a metal salt of a first acid, comprising:
a) means for providing a metal pickling process solution containing a metal salt of a first acid;
b) means for adding a second acid to said solution to produce a regenerated first acid and a metal salt of said second acid;
c) means for crystallizing said metal salt of said second acid; and
d) means for removing said metal salt of said second acid from said solution.

12. Apparatus for regenerating a metal pickling process solution containing a metal salt of a first acid as set forth in claim 11, further comprising means for recycling the regenerated first acid to the metal pickling process.

13. Apparatus for regenerating a metal pickling process solution containing a metal salt of a first acid as set forth in claim 11, wherein said first acid is hydrochloric acid and said metal salt of said second acid is ferrous sulfate heptahydrate.

14. Apparatus for regenerating a metal pickling process solution containing a metal salt of a first acid as set forth in claim 11, wherein said means for adding a second acid to said solution metal comprises adding said second acid at a temperature lower than 65 degrees F.

15. A method of regenerating a ferrous metal pickling process solution containing ferrous chloride, comprising:
a) providing a ferrous metal pickling process solution containing ferrous chloride;
b) adding sulfuric acid to said solution to produce regenerated hydrochloric acid and ferrous sulfate;
c) crystallizing ferrous sulfate heptahydrate; and
d) removing said ferrous sulfate heptahydrate from said solution.

16. A method as set forth in claim 15, further comprising the step of recycling the regenerated hydrochloric acid to the ferrous metal pickling process.

17. A method as set forth in claim 15, wherein said sulfuric acid is added to said solution at a temperature between about 25 degrees F. and about 35 degrees F.

18. A method as set forth in claim 15, further comprising the step of decreasing the solubility of said ferrous sulfate.

19. A method as set forth in claim 18, wherein the step of decreasing said solubility comprises adding sodium sulfate.

20. A method as set forth in claim 15, wherein said sulfuric acid is added in excess of the stoichiometric amount.

21. A method of pickling a metal, comprising:
a) contacting said metal with a solution including a first acid for a time sufficient to provide pickling;
b) removing said metal from said solution;
c) adding a second acid to said solution to produce a regenerated first acid and a metal salt of said second acid;
d) crystallizing said metal salt of said second acid; and
e) removing said metal salt of said second acid from said solution.

22. A method of regenerating pickling a metal, comprising mixing sulfuric acid with spent hydrochloric acid at a certain temperature and forming FeSO₄ capable of being crystallized by temperature reduction at a specific temperature to 20 degrees Fahrenheit.
